(19) United States
(12) Patent Application Publication
(10) Pub. No.: US 2023/0008270 A1
(43) Pub. Date: Jan. 12, 2023

(54) METHOD FOR FIXING AN ELECTRICAL CONNECTOR PROVIDED AT ONE END OF AN ELECTRIC CABLE TO AN ELECTRICAL TERMINAL, CORRESPONDING INTERMEDIATE SUPPORT, AND DEVICE HAVING SUCH AN INTERMEDIATE SUPPORT

(71) Applicant: Valeo Siemens eAutomotive France SAS, Cergy (FR)

(72) Inventors: Paul Doublet, Sartrouville (FR); Alwin Moceri, Pontoise Sainte-Honorine (FR)

(73) Assignee: Valeo Siemens eAutomotive France SAS, Cergy (FR)

(21) Appl. No.: 17/787,034

(22) PCT Filed: Dec. 14, 2020
(86) PCT No.: PCT/EP2020/085890

§ 371 Date: Jun. 17, 2022

(30) Foreign Application Priority Data
Dec. 19, 2019 (FR) 1914882

(51) Int. Cl. H01R 4/30; H01R 9/16; H01R 43/00

(52) U.S. Cl. CPC H01R 4/305; H01R 9/16; H01R 43/00; H01R 2201/26; H01R 11/12

(57) ABSTRACT

The fixing method involves the fixing, for example by screwing, of the electrical connector (202) to the electrical terminal (210). It also involves, before the fixing of the electrical connector (202) to the electrical terminal (210): fixing of the electrical terminal (210) to an intermediate support (206), and the engagement of the electrical connector (202) with at least one element (410, 416) of the intermediate support (206) in order to keep the electrical connector (202) in position with respect to the intermediate support (210).

The present invention relates to a method for fixing an electrical connector provided at one end of an electric cable to an electrical terminal, a corresponding intermediate support, and a device comprising such a support.

A method for fixing an electrical connector provided at one end of an electric cable to an electrical terminal is known in the prior art, comprising a step of fixing, for example by screwing, the connector to the terminal. The terminal can be a rigid lead frame in contact with a conductor track on a printed circuit board or the printed circuit board track itself.

To perform this fixing operation, it is known that an operator holds the connector against the terminal with one hand, while handling the screwing machine with the other hand. Thus, because the connector must be held manually against the terminal, it is not possible to automate this screwing step. However, the precision of the screwing by hand depends on the skill of the operator, so if the screwing performed by the operator is unsteady, the screwing generates waste and risks generating metal particles near the electronic board, or even on it, which could damage it.

Thus, it may be desirable to provide a fixing method that automates the step for fixing the connector to the terminal.

Thus, a method for fixing an electrical connector provided at one end of an electric cable to an electrical terminal is proposed, comprising a step of:
fixing, for example by screwing, the electrical connector to the electrical terminal;
   characterized in that the method further comprises, prior to the fixing of the connector to the terminal, the steps of:
fixing the electrical terminal to an intermediate part; and
engaging the electrical connector with at least one element of the intermediate part to hold the electrical connector in place relative to the intermediate part.

Thus, thanks to the invention, because the terminal is fixed relative to the intermediate part and the cable connector is held in place relative to the intermediate part, the cable connector is also held in place relative to the terminal. Thus, the operator does not need to hold the connector in place when fixing, for example screwing, the connector to the terminal. As a result, this fixing step can be automated.

Optionally, the engagement is performed after the electrical terminal is fixed to the intermediate support, the method further comprises placing at least a portion of the electrical connector against the electrical terminal, and the at least one element comprises at least one stop designed to hold the electrical connector against the electrical terminal.

Also optionally, the at least one stop comprises a fixed stop of the intermediate support.

Also optionally, the at least one stop comprises a movable stop provided on a flexible lever for clipping the electrical connector against the electrical terminal.

Also optionally, the at least one element comprises a hole formed in the intermediate support and the engagement comprises forcibly pressing at least a portion of the electrical connector into the hole.

Also provided is an intermediate support for at least one electrical connector provided at one end of an electric cable, comprising, for each electrical connector, at least one element designed to cooperate with the electrical connector to hold the electrical connector in place relative to the intermediate support.

Optionally, the at least one element comprises a hole into which at least a portion of the electrical connector is intended to be forcibly pressed.

Also proposed is an assembly of an intermediate support according to the invention and an electrical terminal, fixed to each other, wherein the electrical terminal comprises:
a plate having an upper face oriented upwards in a vertical direction perpendicular to the upper face and for example intended to come into contact with a conductive track of a printed circuit board;
for each electrical connector, a contact portion for contacting that electrical connector, the contact portion(s) being located, in the vertical direction, below the upper face; and
at least one bent portion connecting the plate to each contact portion.

Optionally, the at least one element comprises at least one stop designed to cooperate with the contact portion of the terminal to hold the electrical connector in place relative to the intermediate support.

Also optionally, the at least one stop comprises a fixed stop.

Also optionally, the at least one stop comprises a movable stop provided on a flexible lever for clipping the electrical connector against the electrical terminal.

Also proposed is a device comprising:
an electrical connector provided at one end of an electric cable; and
an assembly according to the invention, of an intermediate support and an electrical terminal;
   the electrical connector comprising a contact portion designed to contact the contact portion of the terminal, a fixing portion at the end of the electric cable and a bent portion connecting the contact portion to the fixing portion, the fixing portion forming a shoulder designed to be held in place by being clipped by the movable stop of the flexible lever.

Also proposed is a device comprising:
an electrical connector provided at one end of an electric cable; and
an intermediate support according to the invention;
   wherein the electrical connector comprises a contact portion for contacting an electrical terminal and an insert fixed to the contact portion and forcibly pressed into the hole of the intermediate support.

The invention will be better understood with the aid of the following description, given merely by way of example and drafted with reference to the appended drawings; in which:

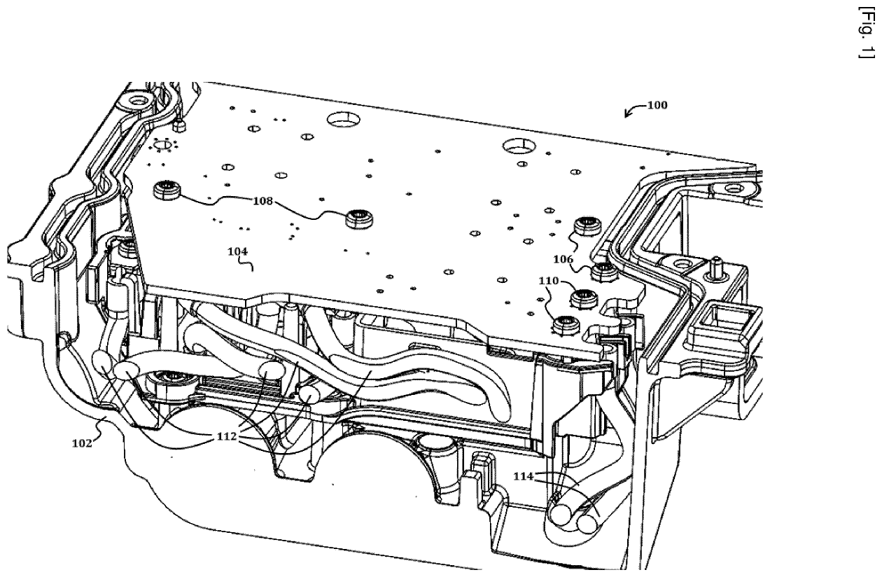

FIG. 1 is a three-dimensional view of an electrical device implementing the invention and comprising a housing with a printed circuit board and electric cables therein,

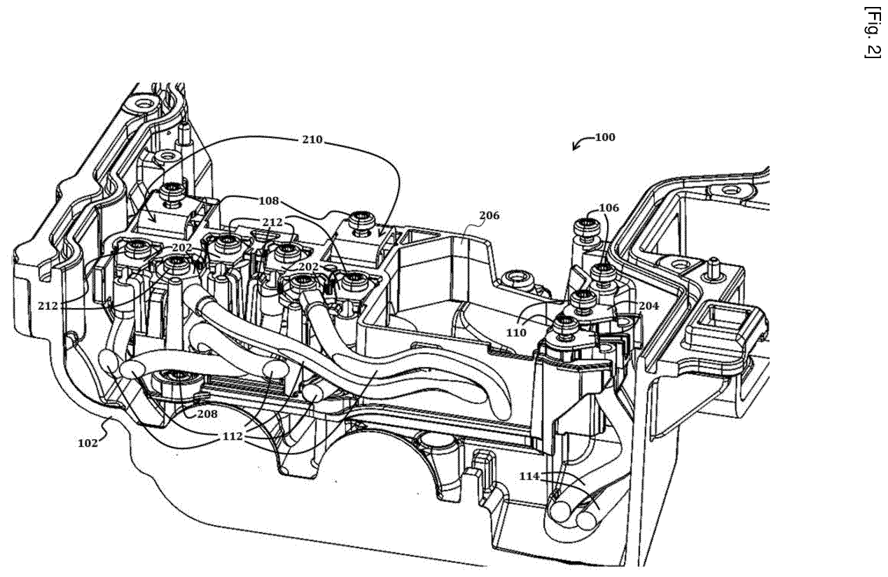

FIG. 2 is a three-dimensional view similar to FIG. 1, without the printed circuit board, to illustrate an intermediate support for electrical connectors provided at ends of the cables,

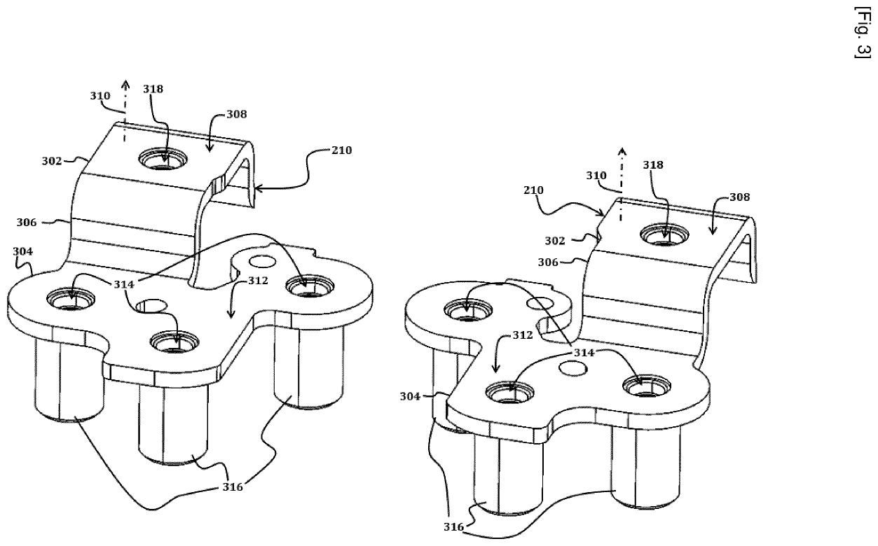

FIG. 3 is a three-dimensional view of electrical terminals fixed to the intermediate support, with which the connectors are contacted,

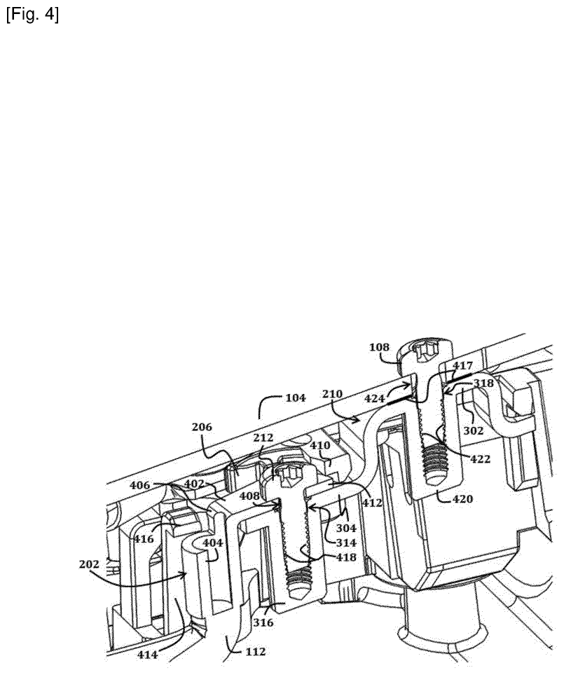

FIG. 4 is a three-dimensional sectional view illustrating the fixing of one of the electrical terminals, on the one hand, to one of the connectors and, on the other hand, to the printed circuit board,

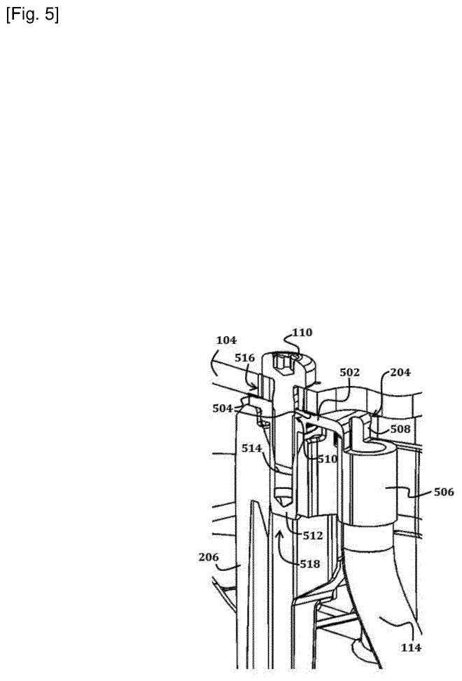

FIG. 5 is a three-dimensional sectional view illustrating the fixing of one of the connectors to the printed circuit board,

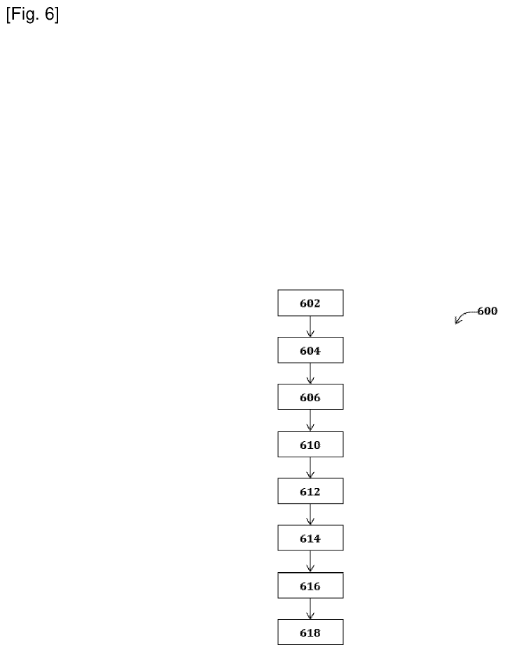

FIG. 6 is a block diagram illustrating the successive steps of an example of an assembly process according to the invention for the device in the preceding figures, and

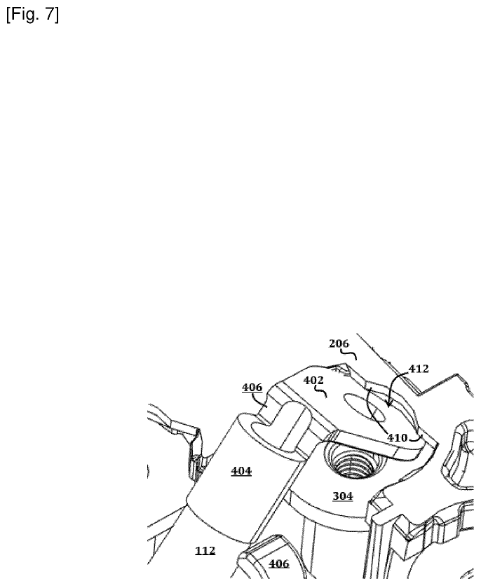

FIG. 7 is a three-dimensional view illustrating one of the connectors whilst being placed on the intermediate support.

With reference to FIGS. 1-5, a non-limiting example of an electrical device 100 implementing the invention will now be described.

In the described example, the device 100 is an on board charger (“OBC”), i.e., an AC to DC voltage converter designed to receive an AC voltage from a motor vehicle charging station and convert it to a DC voltage, for example, between 350 V and 650 V, for charging a battery of the motor vehicle and powering electrical components of the motor vehicle. The battery charger can further be designed, when the motor vehicle is not in battery charging mode, for example when not connected to a charging station, to smooth the battery voltage for supplying the electrical components of the motor vehicle.

With reference to FIG. 1, the device 100 first comprises a housing 102, for example made of aluminum.

The device 100 further comprises a printed circuit board (“PCB”) 104 extending into the housing 102 and fixed thereto, by screwing in screws 106 in the example described. The printed circuit board 104 holds and electrically connects electrical components (not shown) to each other, in order to produce an electronic circuit implementing at least some of the functions of the device 100. The printed circuit board 104 is further fixed to electrical terminals (not visible in FIG. 1 and to be described later) by screwing with screws 108 in the example described, and to electrical connectors (not visible in FIG. 1 and to be described later), by screwing with screws 110 in the example described.

The device 100 further comprises electric cables 112, 114 extending into the housing 102.

With reference to FIG. 2, where the printed circuit board 104 is not shown, electrical end connectors 202, 204 are provided at one end of the cables 112, 114, in order, as will become apparent later, to electrically connect these cables 112, 114 to the printed circuit board 104.

To hold the end connectors 202, 204 in place, the device 100 comprises an intermediate support 206 of the end connectors 202, 204. The intermediate support 206 is preferably electrically insulating, for example made of plastic, extends into the housing 102, and is fixed thereto, by screwing in screws 208 in the example described.

The device 100 further comprises two electrical terminals 210 fixed to the intermediate support 206 and designed to electrically connect the end connectors 202 to the printed circuit board 104, For this purpose, on one side, the end connectors 202 are fixed to the terminals 210 by screwing in screws 212 in the example described, and, on the other side, the printed circuit board 104 is fixed to the terminals 210, by screwing in screws 108 in the example described. The terminals 210 and their fixing to the end connectors 202 and the printed circuit board 104 will be described in more detail with reference to FIGS. 3 and 4.

In the example described, each terminal 210 is fixed to the intermediate support 206 by clipping. Each terminal 210 is, for example, in the form of a self-supporting lead frame, such as a conductive plate made, for example, of copper material.

With reference to FIG. 3, each terminal 210 comprises an upper plate 302 for receiving the printed circuit board 104, at least one lower plate 304 for receiving at least one of the end connectors 202, and at least one bent portion 306 connecting the upper plate 302 to each lower plate 304. In the illustrated example, only one lower plate 304 is provided, and it is designed to receive three end connectors 202.

More specifically, the upper plate 302 has an upper face 308 intended to receive the printed circuit board 104 and oriented upwardly along a vertical direction 310 perpendicular to this upper face 308. Each lower plate 304 is located, in the vertical direction 310, below the upper plate 302 and has an upper face 312, parallel to the upper face 308 of the upper plate 302 in the example described, for receiving each end connector 202 provided for that terminal 210. Thus, when the printed circuit board 104 is fixed to the upper plate 302, each lower plate 304 extends below the printed circuit board 104 at a sufficient distance therefrom so that the printed circuit board 104 passes above the end connectors 202.

To fix each end connector 202 to the lower plate 304 by screwing, a screw receiving hole 314 is provided in the lower plate 304. In addition, the terminal 210 comprises, for each hole 314, a screw-receiving insert 316 fixed to the lower plate 304 on a lower face opposite the upper face 312 and opening into the hole 314.

Similarly, to fix the printed circuit board 104 to the upper plate 302 by screwing, a screw receiving hole 318 is provided in the upper plate 302.

With reference to FIG. 4, the manner in which one of the end connectors 202 is fixed to its associated terminal 210 will now be described in more detail.

As can be seen in this figure, the end connector 202 comprises a contact portion 402 designed to contact the lower plate 304 of the terminal 210, a fixing portion 404 at the end of the cable 112, and an angled portion 406 connecting the contact portion 402 to the fixing portion 404.

In the example described, the end connector 202 is a lug crimped to the end of the cable 112, such that the fixing portion 404 is crimped to the end of the cable 112. In addition, the contact portion 402 is in the form of, for example, a flat ring defining a screw hole 408.

Furthermore, due to the bent portion 406, it will be appreciated that the fixing portion 404 forms a shoulder, relative to the bent portion 406, perpendicular to the vertical direction 310.

In addition, the intermediate support 206 comprises a fixed stop 410 located at a distance from the lower plate 304 of the terminal 210. A front portion 412 of the end connector 202 (the zone of the contact portion 402 opposite the fixing portion 404) is interposed between the lower plate 304 of the terminal 210 and the fixed stop 410 to retain this front portion 412 of the end connector 202. Thus, the fixed stop 410 cooperates with the end connector 202 to hold the latter in place relative to the intermediate support 206. In addition, the fixed stop 410 holds the front portion 412 of the end connector 202 against the lower plate 304 of the terminal 210.

In addition, the intermediate support 206 comprises a flexible lever 414 for clipping the end connector 202 having, at a free end, a hook forming a movable stop 416 retaining a rear portion of the end connector 202, the fixing portion 404 of the end connector 202 forming a shoulder. Thus, the movable stop 416 cooperates with the end connector 202 to hold the end connector 202 in place relative to the intermediate support 206. In addition, the movable stop 416 retains the end connector 202 against the lower plate 304 of the terminal 210.

In addition, the insert 316 fixed to the lower plate 304 of the terminal 210 has an internal thread 418. Thus, the end connector 202 is fixed to the lower plate 304 of the terminal 210 by the screw 212 that is inserted into the hole 408 and screwed into the internal thread 418.

Furthermore, the printed circuit board 104 is fixed to the terminal 210 by screwing in the screw 108, in order to establish an electrical connection between the terminal 210 and a conductive track 417, for example a copper layer, extending over the printed circuit board 104. For this purpose, the terminal 210 comprises an insert 420 fixed to the upper plate 302 opposite the upper face 308, for example by crimping, and having an internal thread 422 opening into the hole 318 of the upper plate 302 of the terminal 210. Thus, the screw 108 passes through a hole 424 in the printed circuit board 104 and is screwed into the internal thread 422 of the terminal 210.

Preferably, the inserts 316, 420 are closed at the end opposite the screw insertion end 212, 108. Thus, particles removed during the screwing process are contained and do not settle on the printed circuit board 104.

End connectors 202 other than the one shown in FIG. 4 are fixed to the intermediate part 206 and to one of the terminals 210 in the same manner, except that the flexible lever 414 (and thus the movable stop 416) may be omitted, for example if the available space does not allow for its placement.

With reference to FIG. 5, the fixing of each end connector 204 to the intermediate support 206 and the printed circuit board 104 will now be described in more detail.

In the described example, the end connector 204 comprises a contact portion 502 designed to contact an electrical terminal 504 formed in the described example by a conductive track, for example a copper layer, deposited on the printed circuit board 104. The end connector 204 further comprises a fixing portion 506 at the end of the cable 114 and an angled portion 508 connecting the contact portion 502 to the fixing portion 506.

In the example described, the end connector 204 is a lug crimped to the end of the cable 114, such that the fixing portion 506 is crimped to the end of the cable 114. In addition, the contact portion 502 is in the form of, for example, a flat ring defining a screw hole 510.

Also in the example described, the end connector 204 further comprises an insert 512 fixed to the contact portion 502 opposite the printed circuit board 104, for example by crimping, and opening into the hole 510. The insert 512 has an internal thread 514.

Thus, the end connector 204 is fixed to the printed circuit board 104 by the screw 110 passing through a hole 516 in the printed circuit board 104 and through the hole 510 in the end connector 204, and being screwed into the internal thread 514.

In addition, the intermediate support 206 has a hole 518 and the end connector 204 has a portion forcibly pressed into this hole 518 to fix the end connector 204 to the intermediate portion 206, in particular, as will be explained later with reference to FIG. 6, prior to fixing the printed circuit board 104 to the housing 102 and to the end connector 204.

In the example described, the forcefully pressed portion of the end connector 204 comprises at least a portion of the insert 512. Thus, the hole 518 of the intermediate support 206 cooperates with the insert 512 of the end connector 204 to hold the end connector 204 in place relative to the intermediate support 206. In particular, the insert 512, the contact portion 502 and the fixing portion 506 of the end connector 204 form a “U” shape. This advantageous shape improves the retention of the end connector 204.

With reference to FIG. 6, an example process 600 for assembling the device 100 will now be described.

In a step 602, the housing 102 is obtained with the cables 112, 114 (provided with end connectors 202, 204) extending into the housing 102.

In a step 604, the cables 112, 114 are lifted to insert the intermediate support 206 into the housing 102 and then fix it to the housing 102, by screwing in the screws 208 in the example described.

In a step 606, the terminals 210 are positioned and fixed, by clipping in the example described, to the intermediate support 206 so as to be locked in position relative to the intermediate support 206.

In a step 610, each of the end connectors 202, 204 is engaged with at least one element of the intermediate support 206 to hold the end connector 202, 204 in place relative to the intermediate support 206.

For end connectors 202, this engagement first comprises placing the front portion 412 of the end connector 202 between the fixed stop 410 of the intermediate support 206 and the lower plate 304 of the terminal 210. This configuration is illustrated in FIG. 7. As can be seen in this FIG. 7, the remaining contact portion 402 of the end connector 202 then extends at a distance from the lower plate 304 of the terminal 210. Next, the end connector 202 is pivoted with respect to its front portion 412, so as to bring the entire contact portion 402 closer to the lower plate 304 of the terminal 210. If a clipping lever 414 is provided for this end connector 202, then, upon approach towards the lower plate 304, the fixing portion 404 of the end connector 202 is clipped by the flexible lever 414. To this end, this fixing portion 404 pushes back the movable stop 416, which returns to its position behind the fixing portion 404 after the later has moved past. At this point, the configuration shown in FIG. 4 is present, in which the contact portion 402 of the end connector 202 is held by the stops 410, 416 against the lower plate 304 of the terminal 210. Thus, the cooperation of the end connector 202 with the stops 410, 416 holds the end connector 202 in place relative to the intermediate support 206 and against the terminal 210.

For end connectors 204, at least a portion of the end connector 204 is forcibly pressed into the hole 518 of the intermediate support 206. Thus, the engagement with the hole 518 holds the end connector 204 in place relative to the intermediate support 206.

In a step 612, the end connectors 202 are fixed to the terminals 210, by screwing in the screws 212 in the example described. Because of the stops 410, 416, it is not necessary to hold the end connectors 202 by hand, which allows this step to be automated.

In a step 614, the printed circuit board 104 is inserted into and fixed in the housing 102, by screwing in the screws 106 in the example described. In particular, for each terminal 210, the track 417 comes into contact with or at least close to the upper plate 302 of that terminal 210. In addition, the terminal track 504 comes into contact with or at least close to the contact portion 502 of the end connector 204. It will be appreciated that the fixing of the printed circuit board 104 to the housing 102 specifically results in the fixing of the track 504 to the intermediate support 206, via the printed circuit board 104 and the housing 102.

In a step 616, the printed circuit board 104 is fixed to the terminals 210, by screwing in the screws 212 in the example described, which makes it possible, for each terminal 210, to establish stable contact between the track 417 and that terminal 210.

In a step 618, the printed circuit board 104 is fixed to the end connectors 204, by screwing in the screws 110 in the example described, thereby making it possible to establish, for each end connector 204, stable contact between the track 504 and that end connector 204. Because of the forceful insertion into the hole 518 of the intermediate support 206, it is not necessary to hold the end connectors 204 by hand, which allows this step to be automated.

Steps 616 and 618 could be reversed or performed at the same time.

It is clear that a device and method such as those described above can reduce the risk of accidents, by avoiding the need for the operator to hold the cable connector when fixing it to the terminal.

The present invention is not limited to the embodiments described above, but is instead defined by the following claims. It will indeed be apparent to a person skilled in the art that modifications can be made thereto.

Furthermore, the terms used in the claims are not to be understood as limited to the elements of the previously described embodiments, but instead are to be understood as covering an equivalent elements that a person skilled in the art is capable of deducing on the basis of his general knowledge.

1. A method for fixing an electrical connector provided at one end of an electric cable to an electrical terminal, comprising:
fixing by screwing the electrical connector to the electrical terminal; and
prior to the fixing of the electrical connector to the electrical terminal, fixing the electrical terminal to an intermediate support, and engaging the electrical connector with at least one element of the intermediate support to hold the electrical connector in place relative to the intermediate support.

2. The method as claimed in claim 1, wherein the engagement is performed after the electrical terminal is fixed to the intermediate support, the method further comprising, placing at least a portion of the electrical connector against the electrical terminal, and wherein the at least one element comprises at least one stop to hold the electrical connector against the electrical terminal.

3. The method as claimed in claim 2, wherein the at least one stop comprises a fixed stop of the intermediate support.

4. The method as claimed in claim 2, wherein the at least one stop comprises a movable stop provided on a flexible lever for clipping the electrical connector against the electrical terminal.

5. The method as claimed in claim 1, wherein the at least one element comprises a hole formed in the intermediate support, and wherein the engagement comprises forcibly pressing at least a portion of the electrical connector R into the hole.

6. An intermediate support for at least one electrical connector provided at one end of an electric cable, comprising, for each electrical connector, at least one element to cooperate with the electrical connector to hold the electrical connector in place relative to the intermediate support.

7. The intermediate support as claimed in claim 6, wherein the at least one element comprises a hole into which at least a portion of the electrical connector is intended to be forcibly pressed.

8. An assembly comprising:
an intermediate support as claimed in claim 6; and
an electrical terminal, the intermediate support and electrical terminal being fixed to each other, wherein the electrical terminal comprises:
a plate having an upper face oriented upwards in a vertical direction perpendicular to the upper face and for example intended to come into contact with a conductive track of a printed circuit board,
for each electrical connector, a contact portion for contacting that electrical connector, the contact portion(s) being located, in the vertical direction, below the upper face, and
at least one bent portion connecting the plate to each contact portion.

9. The assembly as claimed in claim 8, wherein the at least one element comprises at least one stop to cooperate with the contact portion of the terminal to hold the electrical connector in place relative to the intermediate support.

10. The assembly as claimed in claim 10, therein the at east one stop comprises a fixed stop.

11. The assembly as claimed in claim 9, wherein the at least one stop comprises a movable stop provided on a flexible lever for clipping the electrical connector against the electrical terminal.

12. A device comprising:
an electrical connector provided at one end of an electric cable; and
an assembly as claimed in claim 11, of an intermediate support and an electrical terminal,
the electrical connector comprising a contact portion to contact the contact portion of the terminal, a fixing portion at the end of the electric cable, and a bent portion connecting the contact portion to the fixing portion, the fixing portion forming a shoulder configured to be held in place by being clipped by the movable stop of the flexible lever.

13. A device comprising:
an electrical connector provided at one end of an electric cable; and
an intermediate support as claimed in claim 7,
wherein the electrical connector comprises a contact portion for contacting an electrical terminal and an insert fixed to the contact portion and forcibly pressed into the hole of the intermediate support.
